(19) United States
(12) Patent Application Publication
(10) Pub. No.: US 2021/0053567 A1
(43) Pub. Date: Feb. 25, 2021

(54) IDENTIFYING PULLOVER REGIONS FOR AUTONOMOUS VEHICLES

(71) Applicant: Waymo LLC, Mountain View, CA (US)

(72) Inventors: John Wesley Dyer, Mountain View, CA (US); Michael Epstein, Danville, CA (US); Jonathan Lee Pedersen, Palo Alto, CA (US)

(21) Appl. No.: 16/546,626

(22) Filed: Aug. 21, 2019

(51) Int. Cl. B60W 30/18; G05D 1/00

(52) U.S. Cl. CPC B60W 30/18009; G05D 1/0088; B60W 2550/20; B60W 2550/12; G05D 2201/0213

(57) ABSTRACT

Aspects of the disclosure relate to maneuvering a vehicle in an autonomous driving mode. For instance, a time constraint for a pullover maneuver and a geographic constraint for the pullover maneuver may be identified. The time constraint and the geographic constraint may be input into a model in order to receive a list of qualities for a region, the region including a plurality of pullover locations. Whether to attempt to find a pullover location within the region to perform the pullover maneuver may be determined based on the list of qualities for the region. The vehicle may be maneuvered in the autonomous driving mode based on the determination whether to attempt to find a pullover location within the region.

### BACKGROUND

Autonomous vehicles, such as vehicles which do not require a human driver when operating in an autonomous driving mode, may be used to aid in the transport of passengers or items from one location to another. For such vehicles, pulling over for passengers may be easier in some locations than others. For example, a busy street (high-traffic environments) that rarely has open curb space presents a larger challenge than a quiet residential road (low-traffic environments). Sometimes, these two kinds of environments can even exist near each other and even as close as in the same parking lot. Without knowing the type of environment before the vehicle reaches such environments may lead to suboptimal selection of pullover locations and may cause a vehicle to drive around for quite some time until able to file a place to pullover for either short-term (i.e. a few minutes) or long term (i.e. more than a few minutes) parking.

### SUMMARY

One aspect of the disclosure provides a method of maneuvering a vehicle in an autonomous driving mode. The method includes identifying, by the one or more processors, a time constraint for a pullover maneuver; identifying, by the one or more processors, a geographic constraint for the pullover maneuver; inputting, by the one or more processors, the time constraint and the geographic constraint into a model in order to receive a list of qualities for a region, the region including a plurality of pullover locations; determine, by the one or more processors, whether to attempt to find a pullover location within the region to perform the pullover maneuver based on the list of qualities for the region; and maneuvering, by the one or more processors, the vehicle in the autonomous driving mode based on the determination whether to attempt to find a pullover location within the region.

In one example, the time constraint includes a time of day. In this example, the time of day is identified based on an expected time for the vehicle to reach the region from a current location of the vehicle. In another example, the time constraint includes a day of the week. In another example, the geographic constraint is a location within the region. In this example, the location is a pickup location for a passenger. In addition or alternatively, the location is a drop off location for a passenger. In another example, the geographic constraint is the region. In another example, the list of qualities includes a number of expected available pullover locations within the region for the time constraint. In another example, the list of qualities includes an expected width for pullover locations within the region. In another example, the list of qualities includes an expected length of pullover locations within the region. In another example, the list of qualities includes expected traffic congestion for the time constraint within the region. In another example, the list of qualities includes expected passenger inconvenience value for the region. In another example, the list of qualities includes expected vehicle inconvenience value for other vehicles within the region. In another example, the list of qualities includes a likely number of double-parked vehicles within the region. In another example, the method also includes identifying a second time constraint for a pullover maneuver; identifying a second geographic constraint for the pullover maneuver; and inputting the second time constraint and the second geographic constraint into a model in order to receive a second list of qualities for a second region, the second region including a plurality of pullover locations. In this example, determining whether to attempt to find a pullover location within the second region is further based on the second list of qualities for the second region. In another example, determining whether to attempt to find a pullover location within the region further includes ranking the region and the second region based on a set of desired qualities for the pullover maneuver, the list of qualities, and the second list of qualities. In this example, determining whether to attempt to find a pullover location within the region further includes selecting one of the regions or the second region based on the ranking. In addition or alternatively, the method also includes identifying the set of desired qualities based on a type of the pullover maneuver. In addition or alternatively, maneuvering the vehicle further includes performing the pullover material in the region.

### BRIEF DESCRIPTION OF THE DRAWINGS

FIG. 1 is a functional diagram of an example vehicle in accordance with an exemplary embodiment.

FIGS. 2A-B are an example of map information in accordance with aspects of the disclosure.

FIG. 3 is an example external view of a vehicle in accordance with aspects of the disclosure.

FIG. 4 is a pictorial diagram of an example system in accordance with aspects of the disclosure.

FIG. 5 is a functional diagram of the system of FIG. 4 in accordance with aspects of the disclosure.

FIG. 6 is an example of a section of roadway corresponding to the map information of FIG. 2 in accordance with aspects of the disclosure.

FIG. 7 is an example of the section of roadway and data in accordance with aspects of the disclosure.

FIG. 8 is an example of the section of roadway and data in accordance with aspects of the disclosure.

FIG. 9 is an example of the section of roadway and data in accordance with aspects of the disclosure.

FIG. 10 is an example flow diagram in accordance with aspects of the disclosure.

### DETAILED DESCRIPTION

### Overview

The technology relates to identifying areas where an autonomous vehicle or rather, a vehicle having an autonomous driving mode, may be able to pullover and wait for a passenger to enter or exit the vehicle. For such vehicles, pulling over for passengers may be easier in some locations than others. For example, a busy street (high-traffic environments) that rarely has open curb space presents a larger challenge than a quiet residential road (low-traffic environments). Sometimes, these two kinds of environments can even exist near each other and even as close as in the same parking lot. Without knowing the type of environment before the vehicle reaches such environments may lead to suboptimal selection of pullover locations and may cause a vehicle to drive around for quite some time until able to file a place to pullover for either short-term (i.e. a few minutes) or long term (i.e. more than a few minutes) parking. In order to avoid such situations, a model that identifies expected characteristics of regions where a vehicle may be able to pullover may be used as discussed further below.

In order to build a model, various signals may be collected about pullover locations. These pullover locations may already be known, for instance, and may be stored in map information. Some of these signals may be available for collection while driving a vehicle around and collecting sensor data. Other signals may also be determined for areas around such pullover locations, or regions that include one or more pullover locations.

Using these signals, a model that identifies expected characteristics of regions may be built. The model may be trained such that for a given geographic constraint and time constraint, the model may provide a list of expected qualities for a region. If a specific location is provided, the region may correspond to a region that includes the specific location. In this regard, the signals for a given region where the sensor data corresponding to the signals was collected may be used as training outputs for a machine-learned model, and the specific location or given region and a time when the sensor data was collected may be used as training inputs to the model.

In use, for a given location, a plurality of regions nearby that location may be identified. The regions may be input into the model as geographic constraints or alternatively, some location within that region may be input as the geographic constraint. A time constraint may also be input into the model. Alternatively, other inputs to the model may include additional features of roads within the region such as proximity to places of interest, size, road speed, typical traffic, etc.

For each region or other input, the model may output a list of qualities. Each region may then be ranked based on a type of pullover to be performed in the region. A highest ranked region may then be selected. This highest ranked region or a location within this highest ranked region may be set as a destination for a vehicle. In this regard, the vehicle may be controlled autonomously towards the region and may thereafter identify a particular location to pull over the vehicle based on sensor data collected within the region.

The features described herein may enable a vehicle having an autonomous driving mode to more easily locate pullover locations as in the examples described above. Regions where parking is likely to currently be available can be identified without the vehicle actually having to observe those regions. This may reduce the amount of time that the vehicle may spend looking for a pullover location and also reduce inconvenience convenient to passenger and other road users.

### Example Systems

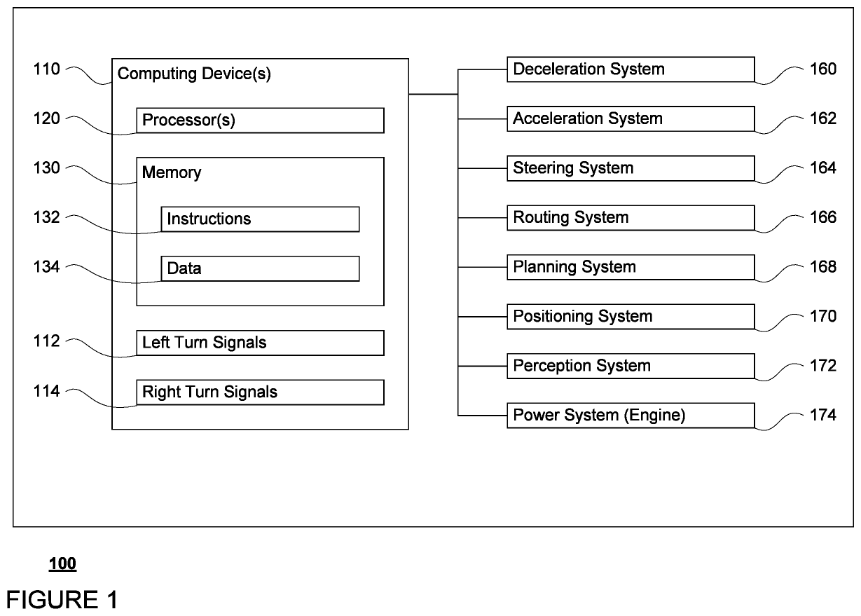

As shown in FIG. 1, a vehicle 100 in accordance with one aspect of the disclosure includes various components. While certain aspects of the disclosure are particularly useful in connection with specific types of vehicles, the vehicle may be any type of vehicle including, but not limited to, cars, trucks, motorcycles, buses, recreational vehicles, etc. The vehicle may have one or more computing devices, such as computing device 110 containing one or more processors 120, memory 130 and other components typically present in general purpose computing devices.

The memory 130 stores information accessible by the one or more processors 120, including instructions 132 and data 134 that may be executed or otherwise used by the processor 120. The memory 130 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. For instance, although the claimed subject matter is not limited by any particular data structure, the data may be stored in computing device registers, in a relational database as a table having a plurality of different fields and records, XML documents or flat files. The data may also be formatted in any computing device-readable format.

The one or more processor 120 may be any conventional processors, such as commercially available CPUs or GPUs. Alternatively, the one or more processors may be a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of computing device 110. Accordingly, references to a processor or computing device will be understood to include references to a collection of processors or computing devices or memories that may or may not operate in parallel.

In one aspect the computing devices 110 may be part of an autonomous control system capable of communicating with various components of the vehicle in order to control the vehicle in an autonomous driving mode. For example, returning to FIG. 1, the computing devices 110 may be in communication with various systems of vehicle 100, such as deceleration system 160, acceleration system 162, steering system 164, routing system 166, planning system 168, positioning system 170, and perception system 172 in order to control the movement, speed, etc. of vehicle 100 in accordance with the instructions 134 of memory 130 in the autonomous driving mode.

As an example, computing devices 110 may interact with deceleration system 160 and acceleration system 162 in order to control the speed of the vehicle. Similarly, steering system 164 may be used by computing devices 110 in order to control the direction of vehicle 100. For example, if vehicle 100 is configured for use on a road, such as a car or truck, the steering system may include components to control the angle of wheels to turn the vehicle.

Planning system 168 may be used by computing devices 110 in order to determine and follow a route generated by a routing system 166 to a location. For instance, the routing system 166 may use map information to determine a route from a current location of the vehicle to a drop off location. The planning system 168 may periodically generate trajectories, or short-term plans for controlling the vehicle for some period of time into the future, in order to follow the route to the destination. In this regard, the planning system 168, routing system 166, and/or data 134 may store detailed map information, e.g., highly detailed maps identifying the shape and elevation of roadways, lane lines, intersections, crosswalks, speed limits, traffic signals, buildings, signs, real time traffic information, vegetation, or other such objects and information.

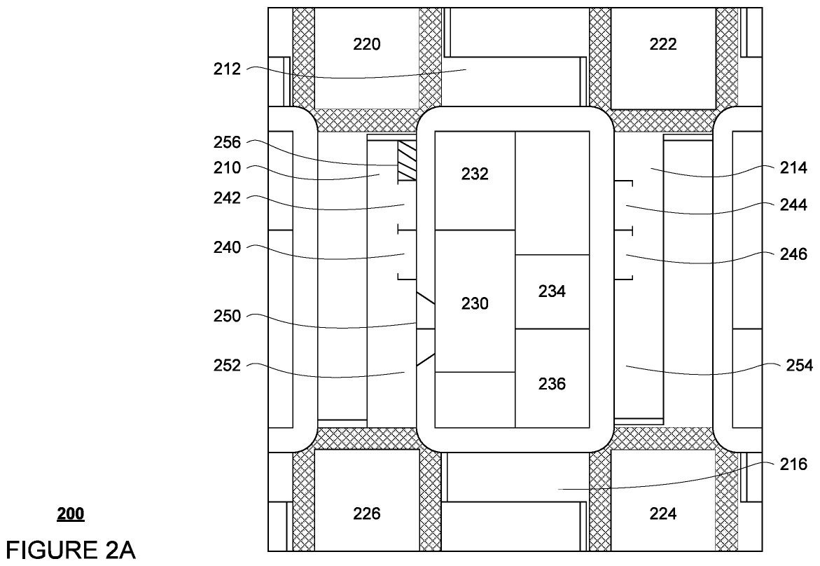

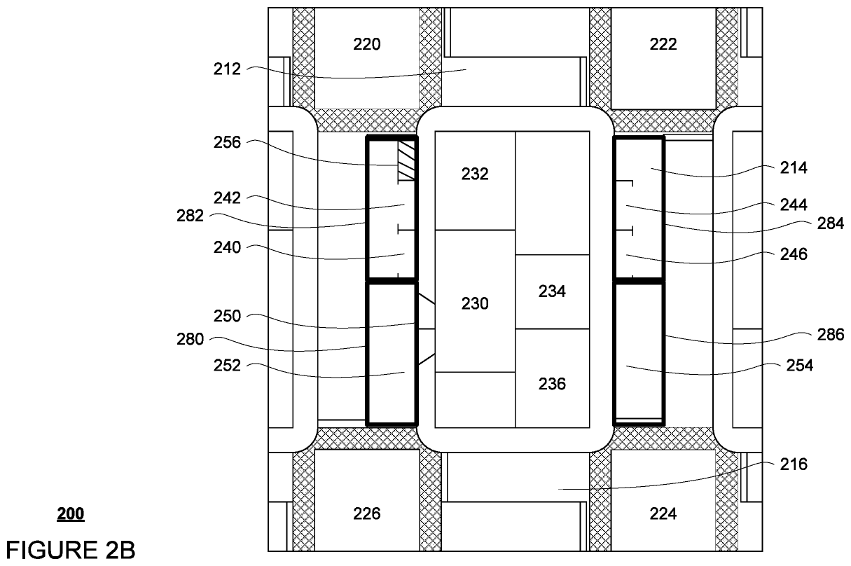

FIGS. 2A and 2B are a high-level example of map information 200 for an example city or other geographical area for the purposes of demonstration. In this example, the map information 200 includes a plurality of different features that identify the shape and location of various features such as lanes 210-216, intersections 220-226, buildings 230-236, parking spaces 240-246, a driveway entrance (for example to a parking garage or other location) 250, shoulder areas 252-254, and no parking zone 256. Together, these features correspond to a single city block. The map information 200 may identify pullover locations or areas such as parking spaces (such as parking spaces 240-246), shoulder areas (such as shoulder areas 252-254), parking lots, loading zones, etc. where a vehicle can stop and wait for a passenger to exit and/or enter the vehicle. The map 200 may be a part of the detailed maps described above and used by the various computing devices of vehicle 100 in order to maneuver the vehicle 100.

Turning to FIG. 2B, the map information may be subdivided into a plurality of regions 280, 282, 284, 286 that each include one or more pullover locations. Each region may include one or more pullover locations and may be a predetermined geographic area defined in the map information 200. For instance, a region may be formed from a plurality of road segments of the map information aggregated together. In this regard, a region may include a complete or a portion of a block, one or both sides of a street, an area of a parking lot, etc. Each region may be identifiable by an identifier, which may relate to the geographical boundaries of the region or some other code which can be used to find the region in the map information. In the example of FIG. 2, region 280 includes shoulder area 252 where a vehicle could potentially stop and wait, region 282 includes parking spaces 240, 242, region 284 includes parking spaces 244, 246, and region 286 includes shoulder area 254 where a vehicle could stop and wait. For simplicity, only a few regions are shown of a particular shape and size, but regions may also be of different shapes and sizes.

Although the map information is depicted herein as an image-based map, the map information need not be entirely image based (for example, raster). For example, the map information may include one or more roadgraphs or graph networks of information such as roads, lanes, intersections, and the connections between these features which may be represented by road segments. Each feature may be stored as graph data and may be associated with information such as a geographic location and whether or not it is linked to other related features, for example, a stop sign may be linked to a road and an intersection, etc. In some examples, the associated data may include grid-based indices of a roadgraph to allow for efficient lookup of certain roadgraph features.

Positioning system 170 may be used by computing devices 110 in order to determine the vehicle's relative or absolute position on a map or on the earth. For example, the positioning system 170 may include a GPS receiver to determine the device's latitude, longitude and/or altitude position. Other location systems such as laser-based localization systems, inertial-aided GPS, or camera-based localization may also be used to identify the location of the vehicle. The location of the vehicle may include an absolute geographical location, such as latitude, longitude, and altitude as well as relative location information, such as location relative to other cars immediately around it which can often be determined with less noise that absolute geographical location.

The positioning system 170 may also include other devices in communication with the computing devices of the computing devices 110, such as an accelerometer, gyroscope or another direction/speed detection device to determine the direction and speed of the vehicle or changes thereto. By way of example only, an acceleration device may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the computing device 110, other computing devices and combinations of the foregoing.

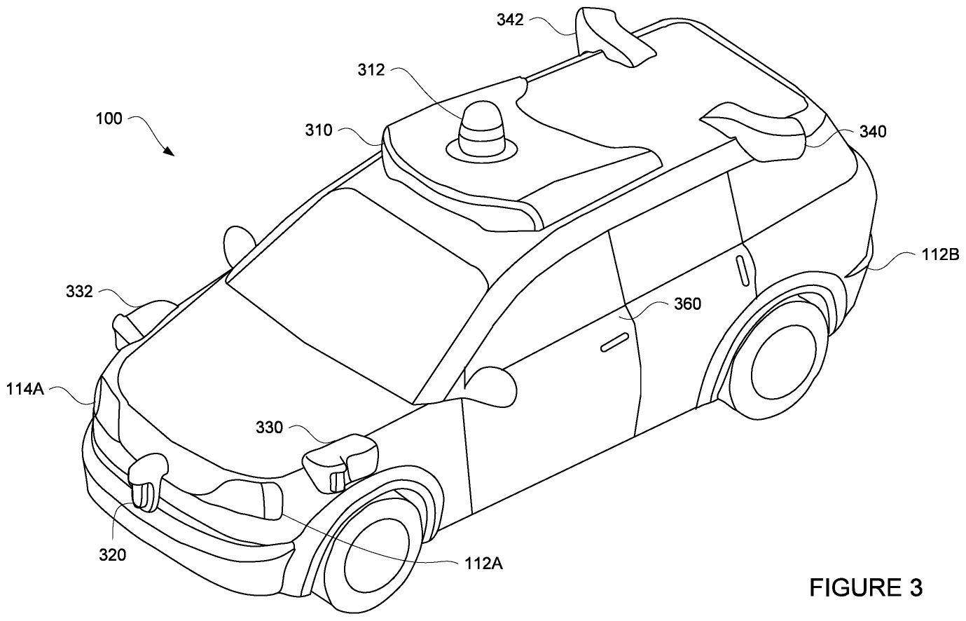

The perception system 172 also includes one or more components for detecting objects external to the vehicle such as other vehicles, obstacles in the roadway, traffic signals, signs, trees, etc. For example, the perception system 172 may include lasers, sonar, radar, cameras and/or any other detection devices that record data which may be processed by the computing devices of the computing devices 110. In the case where the vehicle is a passenger vehicle such as a minivan, the minivan may include a laser or other sensors mounted on the roof or other convenient location. For instance, FIG. 3 is an example external view of vehicle 100. In this example, roof-top housing 310 and dome housing 312 may include a LIDAR sensor as well as various cameras and radar units. In addition, housing 320 located at the front end of vehicle 100 and housings 330, 332 on the driver's and passenger's sides of the vehicle may each store a LIDAR sensor. For example, housing 330 is located in front of driver door 360. Vehicle 100 also includes housings 340, 342 for radar units and/or cameras also located on the roof of vehicle 100. Additional radar units and cameras (not shown) may be located at the front and rear ends of vehicle 100 and/or on other positions along the roof or roof-top housing 310. FIG. 3 also depicts left and right turn signals 112, 114. In this example, front left turn signal 112A, rear left turn signal 112B, and front right turn signal 114A are depicted, but a right rear turn signal is not visible from the perspective of FIG. 3.

The computing devices 110 may capable of communicating with various components of the vehicle in order to control the movement of vehicle 100 according to primary vehicle control code of memory of the computing devices 110. For example, returning to FIG. 1, the computing devices 110 may include various computing devices in communication with various systems of vehicle 100, such as deceleration system 160, acceleration system 162, steering system 164, routing system 166, planning system 168, positioning system 170, perception system 172, and power system 174 (i.e. the vehicle's engine or motor) in order to control the movement, speed, etc. of vehicle 100 in accordance with the instructions 134 of memory 130.

The various systems of the vehicle may function using autonomous vehicle control software in order to determine how to and to control the vehicle. As an example, a perception system software module of the perception system 172 may use sensor data generated by one or more sensors of an autonomous vehicle, such as cameras, LIDAR sensors, radar units, sonar units, etc., to detect and identify objects and their characteristics. These characteristics may include location, type, heading, orientation, speed, acceleration, change in acceleration, size, shape, etc. In some instances, characteristics may be input into a behavior prediction system software module which uses various behavior models based on object type to output a predicted future behavior for a detected object. In other instances, the characteristics may be put into one or more detection system software modules, such as a traffic light detection system software module configured to detect the states of known traffic signals, construction zone detection system software module configured to detect construction zones from sensor data generated by the one or more sensors of the vehicle as well as an emergency vehicle detection system configured to detect emergency vehicles from sensor data generated by sensors of the vehicle. Each of these detection system software modules may uses various models to output a likelihood of a construction zone or an object being an emergency vehicle. Detected objects, predicted future behaviors, various likelihoods from detection system software modules, the map information identifying the vehicle's environment, position information from the positioning system 170 identifying the location and orientation of the vehicle, a destination for the vehicle as well as feedback from various other systems of the vehicle may be input into a planning system software module of the planning system 168. The planning system may use this input to generate trajectories for the vehicle to follow for some brief period of time into the future based on a route generated by a routing module of the routing system 166. A control system software module of the computing devices 110 may be configured to control movement of the vehicle, for instance by controlling braking, acceleration and steering of the vehicle, in order to follow a trajectory.

The computing devices 110 may control the vehicle in an autonomous driving mode by controlling various components. For instance, by way of example, the computing devices 110 may navigate the vehicle to a destination location completely autonomously using data from the detailed map information and planning system 168. The computing devices 110 may use the positioning system 170 to determine the vehicle's location and perception system 172 to detect and respond to objects when needed to reach the location safely. Again, in order to do so, computing device 110 may generate trajectories and cause the vehicle to follow these trajectories, for instance, by causing the vehicle to accelerate (e.g., by supplying fuel or other energy to the engine or power system 174 by acceleration system 162), decelerate (e.g., by decreasing the fuel supplied to the engine or power system 174, changing gears, and/or by applying brakes by deceleration system 160), change direction (e.g., by turning the front or rear wheels of vehicle 100 by steering system 164), and signal such changes (e.g., by lighting turn signals 112 or 114 of the signaling system). Thus, the acceleration system 162 and deceleration system 160 may be a part of a drivetrain that includes various components between an engine of the vehicle and the wheels of the vehicle. Again, by controlling these systems, computing devices 110 may also control the drivetrain of the vehicle in order to maneuver the vehicle autonomously.

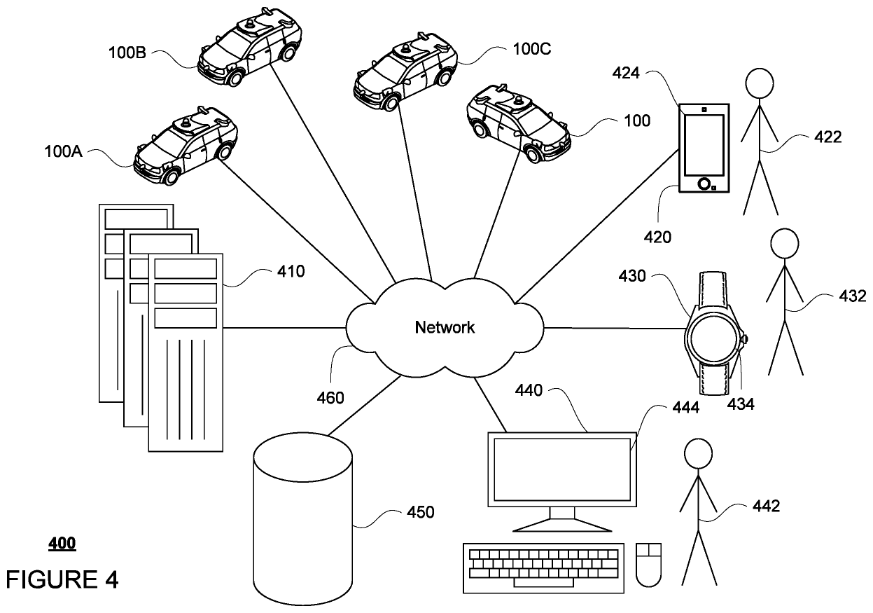

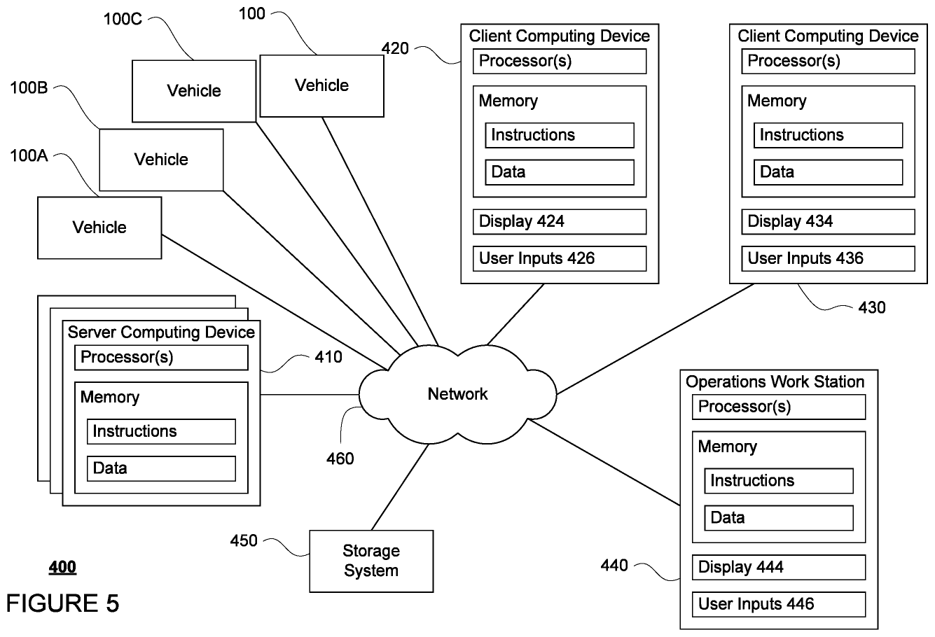

Computing device 110 of vehicle 100 may also receive or transfer information to and from other computing devices, such as those computing devices that are a part of the transportation service as well as other computing devices. FIGS. 4 and 5 are pictorial and functional diagrams, respectively, of an example system 300 that includes a plurality of computing devices 410, 420, 430, 440 and a storage system 450 connected via a network 460. System 300 also includes vehicle 100A-D, which may be configured the same as or similarly to vehicle 100. Although only a few vehicles and computing devices are depicted for simplicity, a typical system may include significantly more.

As shown in FIG. 4, each of computing devices 410, 420, 430, 440 may include one or more processors, memory, data and instructions. Such processors, memories, data and instructions may be configured similarly to one or more processors 120, memory 130, data 134, and instructions 132 of computing device 110.

The network 460, and intervening nodes, may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, one or more computing devices 410 may include one or more server computing devices having a plurality of computing devices, e.g., a load balanced server farm, that exchange information with different nodes of a network for the purpose of receiving, processing and transmitting the data to and from other computing devices. For instance, one or more computing devices 410 may include one or more server computing devices that are capable of communicating with computing device 110 of vehicle 100 or a similar computing device of vehicle 100A as well as computing devices 420, 430, 440 via the network 460. For example, vehicles 100, 100A, may be a part of a fleet of vehicles that can be dispatched by server computing devices to various locations. In this regard, the server computing devices 410 may function as a dispatching server computing system (dispatching system) which can be used to dispatch vehicles such as vehicle 100 and vehicle 100A to different locations in order to pick up and drop off passengers. In addition, server computing devices 410 may use network 460 to transmit and present information to a user, such as user 422, 432, 442 on a display, such as displays 424, 434, 444 of computing devices 420, 430, 440. In this regard, computing devices 420, 430, 440 may be considered client computing devices.

As shown in FIG. 4, each client computing device 420, 430, 440 may be a personal computing device intended for use by a user 422, 432, 442, and have all of the components normally used in connection with a personal computing device including a one or more processors (e.g., a central processing unit (CPU)), memory (e.g., RAM and internal hard drives) storing data and instructions, a display such as displays 424, 434, 444 (e.g., a monitor having a screen, a touch-screen, a projector, a television, or other device that is operable to display information), and user input devices 426, 436, 446 (e.g., a mouse, keyboard, touchscreen or microphone). The client computing devices may also include a camera for recording video streams, speakers, a network interface device, and all of the components used for connecting these elements to one another.

Although the client computing devices 420, 430, and 440 may each comprise a full-sized personal computing device, they may alternatively comprise mobile computing devices capable of wirelessly exchanging data with a server over a network such as the Internet. By way of example only, client computing device 420 may be a mobile phone or a device such as a wireless-enabled PDA, a tablet PC, a wearable computing device or system, or a netbook that is capable of obtaining information via the Internet or other networks. In another example, client computing device 430 may be a wearable computing system, shown as a wristwatch as shown in FIG. 3. As an example, the user may input information using a small keyboard, a keypad, microphone, using visual signals with a camera, or a touch screen.

As with memory 130, storage system 450 can be of any type of computerized storage capable of storing information accessible by the server computing devices 410, such as a hard-drive, memory card, ROM, RAM, DVD, CD-ROM, write-capable, and read-only memories. In addition, storage system 450 may include a distributed storage system where data is stored on a plurality of different storage devices which may be physically located at the same or different geographic locations. Storage system 450 may be connected to the computing devices via the network 460 as shown in FIGS. 4 and 5, and/or may be directly connected to or incorporated into any of the computing devices 110, 410, 420, 430, 440, etc.

The storage system 450 may store one or more models as discussed below as well as various signals relating to pullovers. For instance, the various signals may be collected about pullover (where a vehicle can literally “pullover” or simply park in a designated parking space) locations. These pullover locations may already be known, for instance, and may be stored in map information as described above. Some of these signals may collected while driving a vehicle, such as any of vehicles 100, 100A, 100B, 100C, around and collecting sensor data such as available curb space (i.e. how much of gap or how much room a vehicle has to fit within a pullover location has), how far to the right a vehicle is able to get (i.e. width of the pullover location), traffic congestion at different days of the week and times of day, the type of road at which the pullover location is located (i.e. high speed/highway or low speed/residential), whether a pullover location is occupied, whether a vehicle is double-parked at the pullover location, as well as other types of information which can change dynamically, whether the pullover location is proximate to a busy driveway, etc. For instance, as vehicles, such as vehicles 100, 100A, 100B, 100C of the fleet of vehicles or other vehicles, are driven around, sensors, such as the sensors of the perception system 172 described above, may collect sensor data. Such signals may be identified in real time by computing devices of those vehicles or offline by the server computing devices 410 and/or human operators from the sensor data. For example, in the driveway example, as vehicles are driven around, they may observe how often other road users are pulling into or out of driveways (which may include residential driveways, commercial driveways, apartment complex entrances or other drivable surfaces which may not be included in the map information). This may indicate whether the driveway is a residential driveway or rarely used commercial one as compared to a busy commercial driveway or busy apartment complex driveway.

Other signals stored in the storage system 450 may also be determined by the server computing devices and/or human operators for areas around such pullover locations, or the regions discussed above. These other signals may include the number of available pullover locations (as the vehicle drives through the region), how congested such areas are, how many other vehicles are pulling over in the region (as the vehicle drives through the region), how many vehicles are double parked within the region, whether there are other types of road users (such as pedestrians or cyclists) within the region, etc.

Other signals stored in the storage system 450 may only be available or determined by the server computing devices 410 and/or human operators after a pullover is actually attempted by one of the vehicles of the fleet. Such signals may include how long passengers take to arrive, board and depart at a pullover location, the passenger inconvenience value of a pullover location, the vehicle inconvenience at pullover location, how long the vehicle is able to stay in a pullover location, etc. The values for passenger inconvenience and vehicle inconvenience may be determined, for instance, on a scale of 0 to 1 using a model which generates such values given map data and sensor data collected during such attempted pullovers. Passenger inconvenience values may represent how convenient a particular pickup up or drop off was for a passenger by measuring how much extra distance is imposed on the passenger by the selection of a particular pullover location. Vehicle inconvenience values may represent how much inconvenience the vehicle imposes on the other road users during the time the vehicle is pulled over by tracking the delta between the other road user's intent and the other road user's progress caused by the vehicle. This vehicle inconvenience value may be determined from prior attempts to pullover which may have caused problems to other road users. For instance, in the driveway example discussed above, if there are driveways that cause problems, these may be associated with a higher vehicle inconvenience value.

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

In order to build a model, the server computing devices 410 may access the signals of the storage system 450 described above. Using these signals or values determined from these signals, a model that identifies expected characteristics of regions may be built by the server computing devices 410. The model may be trained such that for a given geographic constraint (such as a specific location or a region) and time constraint (such as day of the year, calendar month, day of week, and/or time of day), the model may provide a list of expected qualities for a region. In this regard, if a specific location is provided, the region may correspond to a region that includes the specific location. In this regard, the signals or values determined from these signals for a given region where the sensor data corresponding to the signals was collected may be used as training outputs for the model, and the specific location or given region and a time when the sensor data was collected may be used as training inputs to the model. In the case of a machine-learned model, the training may essentially tune parameter values for the model.

The qualities may include, for example, expected average qualities or values for pullover locations within the region determined from the aforementioned signals such as:
A number of expected available pullover locations within the region for the time constraint (defined, for example, as a numerical value)
Expected width of pullover locations within the region (defined, for example, as a distance value)
Expected length of pullover locations within the region (defined, for example, as a distance value)
Expected traffic congestion for the time constraint (defined, for example as “high”, “medium”, or “low” values or a value on a scale of 0 to 1)
The type of road or roads within the region (defined, for example, as “highway” or “surface street”, etc. or rather, numerical values representative of the aforementioned values)
Expected passenger inconvenience (defined, for example, as a numerical value on a scale of 0 to 1)
Expected vehicle inconvenience (defined, for example, as a numerical value on a scale of 0 to 1)
How long the vehicle is able to stay in a pullover location within the region (defined, for example, as an amount of time)
Likely number of double-parked vehicles within the region (defined, for example, as a numerical value)

In some instances, the model input may also include a duration for how long the vehicle may be expected to need to wait at the pullover location. This number may be determined based on where the user is coming from (i.e. whether the passenger is getting out of the vehicle or getting into the vehicle), the number of passengers, the type of boarding (e.g. whether the passenger is coming from a grocery store), etc.

The model and any model parameter values may be sent to the computing devices 110 of vehicle 100 (or any of vehicles 100A, 100B, 100C), for instance via network 260 or otherwise loading this information into the computing devices 110. This information may then be stored in the memory 130 of the computing devices 110 in order to allow the computing devices to use the model to make driving decisions for the vehicle 100.

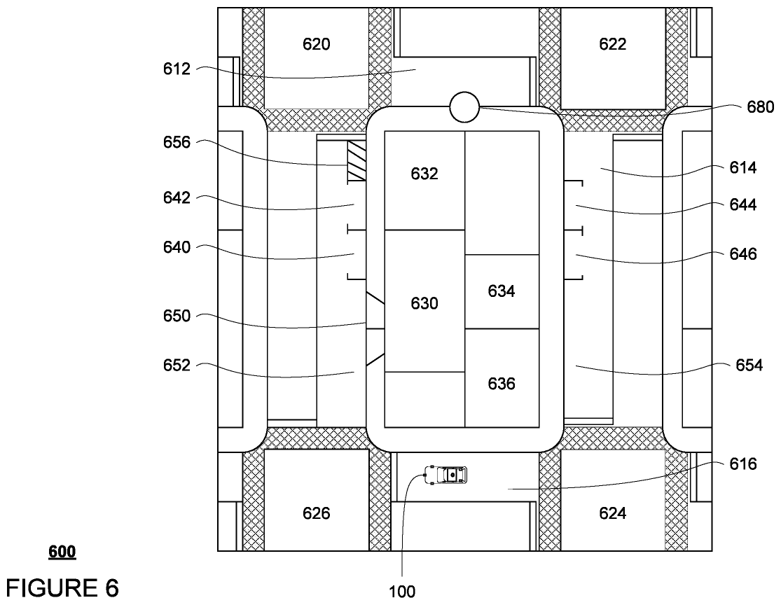

For the purposes of demonstration, FIG. 6 is an example representation of a section of roadway 600 corresponding to the map information 200. In this example, the section of roadway 600 includes various features such as lanes 610-616, intersections 620-626, buildings 630-636, parking spaces 640-646, a driveway entrance (for example to a parking garage or other location) 650, shoulder areas 652-654, and no parking zone 656 that correspond to each of lanes 210-216, intersections 220-226, buildings 230-236, parking spaces 240-246, a driveway entrance (for example to a parking garage or other location) 250, shoulder areas 252-254, and no parking zone 256 of the map information 200. Vehicle 100 is also depicted driving in lane 616 and approaching intersection 626. In this example, vehicle 100 may be attempting a pickup or drop off at the location of marker 680.

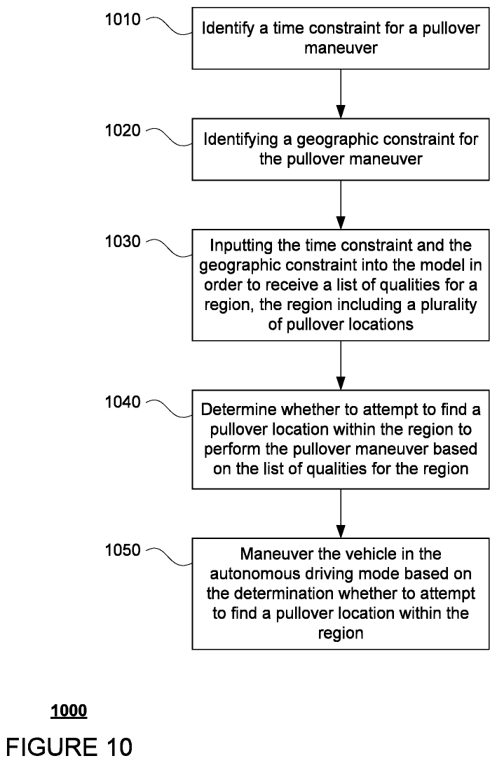

FIG. 10 is an example flow diagram 1000 in accordance with aspects of the disclosure which may be performed by one or more processors of one or more computing devices, such as processors 120 of computing devices 110, in order to maneuver a vehicle having an autonomous driving mode. As shown in blocks 1010 and 1020, a time constraint and a geographic constraint are identified for a pullover maneuver. For instance, a plurality of regions nearby a location may be identified by the computing devices 110. For instance, this given location may be a current location of the vehicle (when the vehicle is unable to find a place to pullover or when the vehicle needs to move to a new pullover location because an emergency vehicle nearby, etc.). Alternatively, the given location may be a pickup or drop off location for a passenger. In either example, the vehicle is very likely to be outside of the plurality of regions or rather, unable to use the sensors of the perception system to determine whether there are available pullover locations in the regions of the plurality of regions.

In some instances, one or a plurality of regions may be identified by the computing devices 110 based on a time and/or distance that a vehicle would need to travel in order to reach each of the regions from the given location. The time constraint may correspond to a current date/time or an expected date/time when a vehicle is expected to reach the region. In this regard, the time it would take for a particular vehicle to reach each region may also be determined. In some instances, if the time it would take a vehicle to reach a region would be too great, such regions may be excluded or filtered from the plurality of regions. As an example, one region might be right across the street, but if it takes too long (e.g. longer than a predetermined period of time such as 5 minutes or more or less) to get there because the vehicle is unable to perform a u-turn for several blocks then that region may not be included in the plurality of regions.

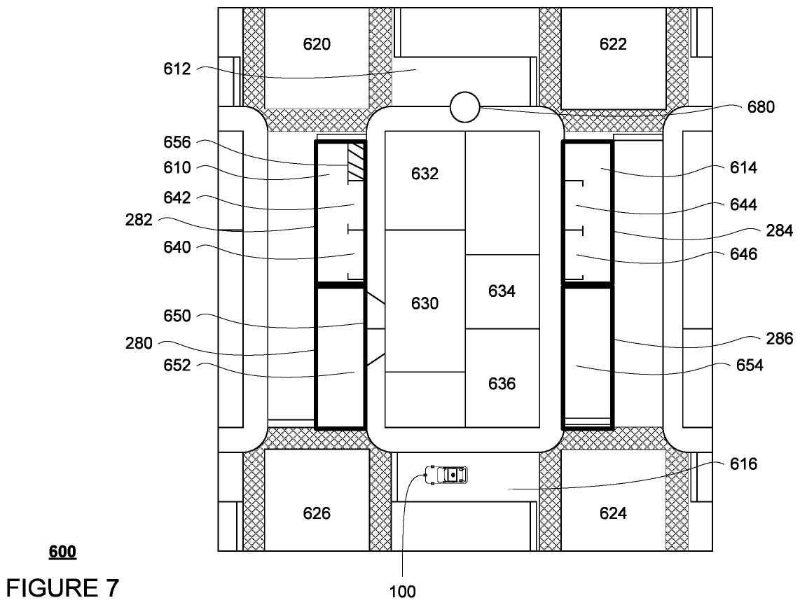

FIG. 7 is an example representation of the section of roadway 600 depicting the regions 280, 282, 284, 286. In this example, the computing devices 110 may identify a plurality of regions, including, for example, regions 280, 282, 284. In addition, in the example of FIG. 7, region 286 may not be identified as it may be considered too far from the marker 680 or take too long for the vehicle 100 to reach as vehicle it would likely take the vehicle too long (i.e. longer than the predetermined period of time) to reach the region 286. Each of these regions (or the identifiers for these regions) or some location within these regions may be identified as a geographic constraint. At this point, when the regions are identified, the sensors of the perception system 172 may not actually be able to perceive the state of available pullover locations. Thus, the computing devices 110 are able to “look beyond” the area in which the vehicle is currently driving in order to find a region that may have available pullover locations.

A time constraint for region 280 may be identified as the current time or a future time when vehicle 100 would be expected to reach the region 280. Similarly, a time constraint for region 282 may be identified as the current time or a future time when vehicle 100 would be expected to reach the region 282, and a time constraint for region 282 may be identified as the current time or a future time when vehicle 100 would be expected to reach the region 284.

Returning to FIG. 10, at block 1030, the time constraint and the geographic constraint are input into a model in order to receive a list of qualities for a region, the region including a plurality of pullover locations. Again, each region of the plurality may be input into the model as geographic constraints or alternatively, some location within that region may be input as the geographic constraint. The identified time constraint may also be input into the model. Alternatively, other inputs to the model may include additional features of roads within the region such as proximity to places of interest, size, road speed, typical traffic, etc.

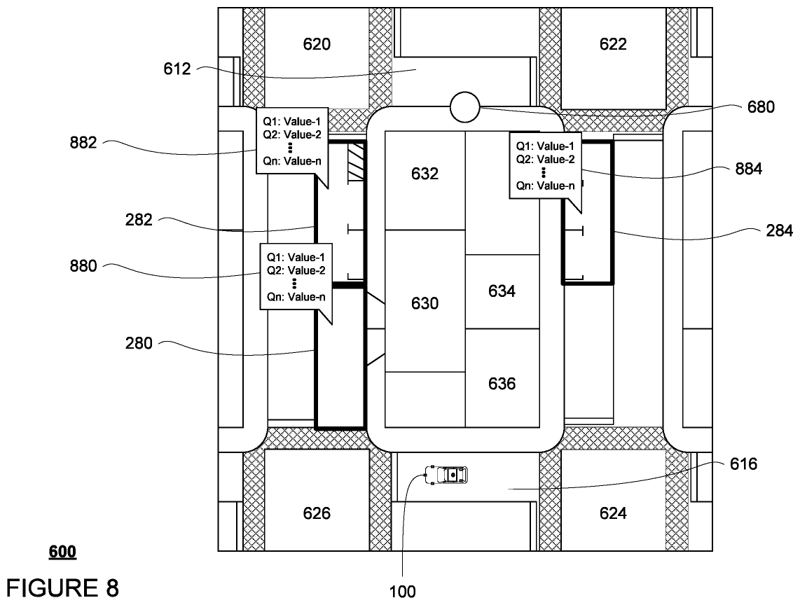

Returning to FIG. 10, at block 1040, whether to attempt to find a pullover location within the region to perform the pullover maneuver is determined based on the list of qualities for the region. For each region or other input, the model may output a list of qualities such as the qualities identified above. Turning to FIG. 8, after inputting the regions and time constraints into the model, each of the regions 280, 282, 284 is now associated with a list of qualities 880, 882, 884. Each quality of the list may have an associated value (value-1, value-2, value-n, etc.), and the values of the same quality between different regions may be the same or different.

Each region may then be ranked based on a type of pullover to be performed by the vehicle 100 in the region. In some instances, each region may be ranked based on a type of pullover to be performed by the vehicle 100 in the region. The type of pullover may be identified from a plurality of predetermined pullover types based on purpose for the vehicle pulling over. Examples of pullover times may include long-term pullovers (i.e. where the vehicle needs to park for more than a few minutes), drop offs (where a passenger is exiting the vehicle), and different types of pickups (where a passenger is entering the vehicle). For example, different types of pickups may include those for a single passenger, those for multiple passengers (which may require more time), those for one or more passengers with cargo (e.g. groceries from a supermarket, luggage from an airport, etc.), and so on. For instance, each type of pullover may be associated with a set of desired qualities for that type of pullover. Each of the regions may be ranked according to which regions most closely meet the set of desired qualities for the pullover type. This ranking may be achieved by using a machine learned model or a hand-tuned cost function.

For example, for long-term pullovers, regions with a longer period of time for how long the vehicle is able to stay in a pullover location within the region may be more desirable and therefore ranked higher than other regions with shorter periods of time. As another example, for short-term pullovers, regions proximate to entrances or exits to a building (such as a valet door for a hotel) may be ranked higher than those that are further away from those entrances or exits despite the potential for inconvenience to other road users which woudl be expected given this behavior. Thus, such regions may be ranked lower for longer-term pullovers.

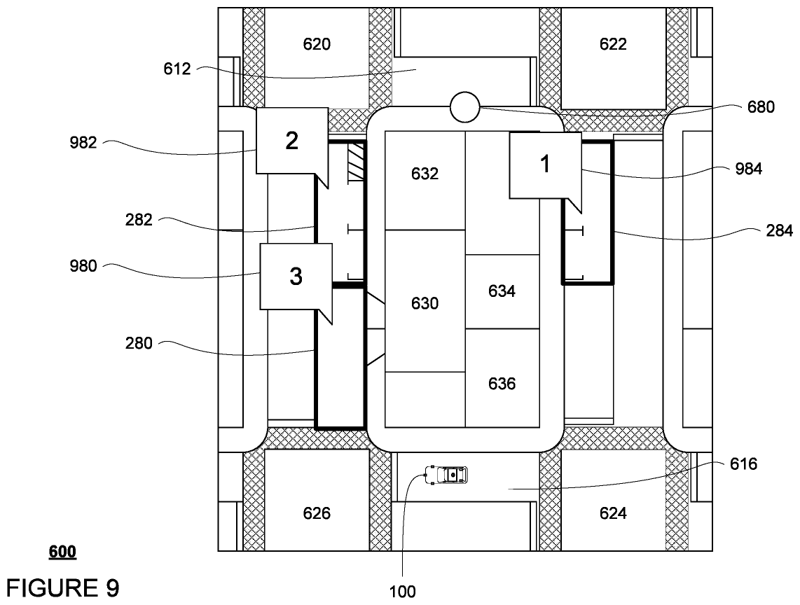

Turning to FIG. 9, after inputting the regions and time constraints into the model, each of the regions 280, 282, 284 is now associated with a ranking 980, 982, 984. In this example, region 284 may have the highest ranking (“1”) because it is most likely to have available parking spaces which correspond to the characteristics or the type of pull over corresponding to the location of marker 610.

A highest ranked region may then be selected. This highest ranked region or a location within this highest ranked region may be set as a destination for a vehicle. Alternatively, the rankings may be reversed such that a lowest ranked region is selected. For example, region 284 may have the ranking of “3” and regions 280 and 282 may have rankings of “2” and “1”, respectively.

As shown at block 1050, the vehicle is maneuvered in the autonomous driving mode based on the determination whether to attempt to find a pullover location within the region. For example, returning to the example of FIG. 9, the computing devices 110 may control the vehicle 100 in order to reach the selected region or rather, the destination set for the vehicle, here region 284, as described above.

In some instances, the qualities of the highest ranked region may be compared by the computing devices 110 with qualities of a region in which the vehicle 100 is currently driving or pulled over in order to determine whether the vehicle should move to the highest ranked region. This may be helpful, for instance, if a vehicle is currently pulled over and waiting for a passenger, and the situation changes. As an example, if another vehicle approaches who may need to nudge around the vehicle, the vehicle's computing devices may do the comparison in order to determine whether it is beneficial to the vehicle, the passenger, and/or the another vehicle to move to another region.

In some instances, the computing devices 100 may possibly identify a region to travel to which may be less convenient to the passenger, but will now have a higher ranking than previously because of the inconvenience to the another vehicle. In such situations, if the vehicle is going to pick up a passenger, a notification may be sent to the passenger's client computing device identifying the highest ranked region and indicating that the vehicle is currently going to that region to drop off the passenger or that the vehicle is able to go to that region to pick up the passenger (and requesting confirmation).

In some instances, real time information about the availability of pullover locations observed by a vehicle, such as any of vehicles 100, 100A, 100B, 100C, may be shared with the dispatching server computing devices and/or other vehicles of the fleet. This information may be used to update the model or in conjunction with the lists of qualities to rank the regions. This information could also be used to directly update the values for the lists of qualities or as some form of additional cost in the ranking. For example. if a region (such as a block of a street) typically has a high number of available pullover locations, but the block is full of parked vehicles, this information may be observed by one vehicle and shared with the server computing devices before another vehicle gets a request for a pick up or drop off within that region. As another example, if a vehicle blocks a driveway (that may have been considered rarely used) causes inconvenience to another road user, this information may be shared and used to avoid repeating the same behavior at the same driveway.

Although the model may be trained offline, that is by one or more server computing devices 410, the model may be used by one or more server computing devices of a dispatching system and/or by one or more computing devices of an autonomous vehicle. For instance, the server computing devices may use the model to identify a region for a given pickup or destination location for a trip (i.e. where a passenger wants to be picked up or dropped off) computing devices 110 may send a request to the server computing devices to identify a region given a current destination for the vehicle and/or pickup or drop off location for a passenger. The region may be identified as described above and then sent to the vehicle. In addition or alternatively, the computing devices 110 may use the model to identify a region when the vehicle is going to a specific destination, is unable to find a pullover location, or when the vehicle needs to move from a pullover location to a new location (such as when an emergency vehicle arrives on scene or the vehicle is blocking traffic, the passenger does not arrive, etc.).

The model may enable various improvements to current transportation services that utilize autonomous vehicles. For instance, when a passenger is requesting or setting up a trip, the dispatching server computing devices may use the model to make recommendations for where a vehicle can pick up or drop off a passenger. For example, the dispatching server computing devices can recommend locations in nearby regions to a requested pickup or drop off location where a vehicle can more easily find a place to pullover. Depending upon the expected and desired qualities of the nearby regions, in turn, may reduce inconvenience to the passenger and/or other vehicles. As noted above, the model may be used to identify regions that are suitable for finding long term parking for a vehicle for a specific point in time, day of the week, etc. In addition, in the event of a problem with a vehicle's systems that requires the vehicle to pullover within a certain period of time, the model may be used to find a nearby location within the period of time where there is likely a pullover location available. Further, in situations in which a vehicle is unable to find a place to pullover, rather than simply looping around to return to the same region without availability, a new region may be identified and the vehicle routed to that new region to find a pullover location. This may be significantly faster than looping and/or waiting for a pullover location to become available. In situations in which regions are specific to different sides of a street, the model may be used to determine which side of the street to approach in order to be more likely to find a pullover location.

The features described herein may enable an autonomous vehicle to more easily locate pullover locations as in the examples described above. Regions where parking is likely to currently be available can be identified before the vehicle has actually arrived “on scene” within the region and without the vehicle actually having to observe those regions. This may reduce the amount of time that the vehicle may spend looking for a pullover location and also reduce inconvenience convenient to passenger and other road users.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of maneuvering a vehicle in an autonomous driving mode, the method comprising:
identifying, by the one or more processors, a time constraint for a pullover maneuver;
identifying, by the one or more processors, a geographic constraint for the pullover maneuver;
inputting, by the one or more processors, the time constraint and the geographic constraint into a model in order to receive a list of qualities for a region, the region including a plurality of pullover locations;
determine, by the one or more processors, whether to attempt to find a pullover location within the region to perform the pullover maneuver based on the list of qualities for the region; and
maneuvering, by the one or more processors, the vehicle in the autonomous driving mode based on the determination whether to attempt to find a pullover location within the region.

2. The method of claim 1, wherein the time constraint includes a time of day.

3. The method of claim 2, wherein the time of day is identified based on an expected time for the vehicle to reach the region from a current location of the vehicle.

4. The method of claim 1, wherein the time constraint includes a day of the week.

5. The method of claim 1, wherein the geographic constraint is a location within the region.

6. The method of claim 5, wherein the location is a pickup location for a passenger.

7. The method of claim 5, wherein the location is a drop off location for a passenger.

8. The method of claim 1 wherein the geographic constraint is the region.

9. The method of claim 1, wherein the list of qualities includes a number of expected available pullover locations within the region for the time constraint.

10. The method of claim 1, wherein the list of qualities includes an expected width for pullover locations within the region.

11. The method of claim 1, wherein the list of qualities includes an expected length of pullover locations within the region.

12. The method of claim 1, wherein the list of qualities includes expected traffic congestion for the time constraint within the region.

13. The method of claim 1, wherein the list of qualities includes expected passenger inconvenience value for the region.

14. The method of claim 1, wherein the list of qualities includes expected vehicle inconvenience value for other vehicles within the region.

15. The method of claim 1, wherein the list of qualities includes a likely number of double-parked vehicles within the region.

16. The method of claim 1, further comprising:
identifying a second time constraint for a pullover maneuver;
identifying a second geographic constraint for the pullover maneuver; and
inputting the second time constraint and the second geographic constraint into a model in order to receive a second list of qualities for a second region, the second region including a plurality of pullover locations, and wherein determining whether to attempt to find a pullover location within the second region is further based on the second list of qualities for the second region.

17. The method of claim 16, wherein determining whether to attempt to find a pullover location within the region further includes ranking the region and the second region based on a set of desired qualities for the pullover maneuver, the list of qualities, and the second list of qualities.

18. The method of claim 17, wherein determining whether to attempt to find a pullover location within the region further includes selecting one of the regions or the second region based on the ranking.

19. The method of claim 17, further comprising identifying the set of desired qualities based on a type of the pullover maneuver.

20. The method of claim 1, wherein maneuvering the vehicle further includes performing the pullover material in the region.
